(19) United States
(12) Patent Application Publication
(10) Pub. No.: US 2016/0001958 A1
(43) Pub. Date: Jan. 7, 2016

(54) ORALLY OPERABLE DISPENSER AND ASSOCIATED METHODS

(71) Applicant: METHODS LLC, Salt Lake City, UT (US)

(72) Inventor: James L. Hardy, North Salt Lake City, UT (US)

(21) Appl. No.: 14/639,865

(22) Filed: Mar. 5, 2015

Related U.S. Application Data
(60) Provisional application No. 61/948,465, filed on Mar. 5, 2014.

(51) Int. Cl. B65D 83/04; A45F 5/00; A45F 5/02; A61J 1/03

(52) U.S. Cl. CPC B65D 83/0445; A61J 1/03; B65D 83/0409; A45F 5/00; A45F 5/02; A45F 2005/008; A45F 2005/002

(57) ABSTRACT

A dispenser for pills, candy or other items includes one or more pods that are configured to hold an item, such as a pill, a piece of candy or the like, to be inserted into an individual's mouth and to enable the individual to remove the item by squeezing the item out of the pod with his or her mouth or otherwise. Such a dispenser may be configured to be worn by an individual or secured to an object that is readily accessible to an individual or his or her mouth. Methods for providing, dispensing and taking (i.e., consuming) items, such as pills or candy, are also disclosed.

### CROSS-REFERNECE TO RELATED APPLICATION

A claim for the benefit of the Mar. 5, 2014 filing date of U.S. Provisional Patent Application No. 61/948,465, titled ORALLY OPERABLE PILL DISPENSER AND ASSOCIATED METHODS (“the '465 Provisional Application”), is hereby made pursuant to 35 U.S.C. §119(e). The entire disclosure of the '465 Provisional Application is hereby incorporated herein.

### TECHNICAL FIELD

This disclosure relates generally to dispensers for pills and other items and, more specifically, to dispensers that are configured to be worn by an individual or that are configured to be secured to an object that is readily accessible to an individual. A dispenser according to this disclosure includes one or more pods that are configured to hold an item, such as a pill, a piece of candy or the like, to be inserted into an individual's mouth and to enable the individual to remove the item by squeezing the item out of the pod with his or her mouth or otherwise. Methods for providing, dispensing and taking (i.e., consuming) items, such as pills or candy, are also disclosed.

### SUMMARY

In various aspects, this disclosure relates to devices that enable items, such as pills (e.g., medicines, nutritional supplements, etc.), candy and the like, to be readily orally dispensed to an individual. Such a device may be referred to herein as an “orally operable dispenser” or, for the sake of simplicity, as a “dispenser.” As used therein, the term “pill” includes pills, caplets, capsules and other embodiments of solid or substantially solid masses of substances that are configured to be swallowed by an individual.

A dispenser according to this disclosure includes one or more pods that may be configured to be received within an individual's mouth and, upon being squeezed by the individual's mouth (e.g., his or her lips, teeth, tongue, etc.) or otherwise (between a thumb and a finger, etc.), or by being subjected to suction (e.g., from the individual's mouth, etc.), to release an item, such as a pill or a piece of candy into the individual's mouth. In various embodiments, such a pod may comprise an outer wall formed from a compliant resilient material, a hollow interior defined by the outer wall, and a slit that may be selectively opened to enable insertion of an item into the hollow interior and removal of the item from the hollow interior.

Each pod may be carried by a base. More specifically, each pod may be oriented (e.g., protrude from the base, etc.) in a manner that enables an individual to readily access the pod. In some embodiments, each pod of a dispenser may be oriented in a manner that enables the individual to place the pod (e.g., a majority of the pod, the entire pod, etc.) into his or her mouth. The base of a dispenser may include a plurality of pods, which may be arranged adjacent to one another, in series, along a length of the base, or in any other suitable arrangement. The base may be configured to place the pods and any pills within the pods at a location where they may be readily accessed by an individual (e.g., by the mouth of the individual, etc.) who will access (e.g., orally consume, etc.) the items within the pods. In one embodiment, the base may be configured to be secured to the individual's wrist. In embodiments where the individual (e.g., an endurance athlete during training or competition, etc.) will access one or more pods of the dispenser with his or her mouth, the individual may position a pod of the dispenser in front of his or her mouth to enable the individual to conveniently access a pod and its contents without disrupting his or her activities (e.g., training, participating in a competition, etc.). In another embodiment, the base may be configured to be secured to a location on an individual's shoulder (e.g., where he or she may access each pod with his or her mouth, etc., which may be useful for athletes, hand and/or arm amputees, individuals whose hand and/or arm movement is limited, etc.). In yet another embodiment, the base may be configured to be secured to an item of clothing.

In some embodiments, a dispenser may include one or more electronic components. A dispenser may include a clock and be configured to provide an individual with an alert when the time has arrived for the individual to access one or more items (e.g., take one or more pills, etc.) from a pod of the dispenser. A dispenser may include a sensor that detects removal of an item from a pod. A dispenser may include a communication component (e.g., a wireless communication element, etc.), which may be configured to communicate information about the dispenser to a remote electronic device (e.g., a computer, a portable electronic device, etc.); for example, information regarding the time at which an item was removed from a pod, the type of item (e.g., pill, etc.) that was removed from the pod and the like.

Another aspect of this disclosure involves use of a dispenser. A readily accessible dispenser with one or more pods including features such as those described above may provide for ready dispensing and, in some embodiments, hands-free dispensing of items, such as pills, candy or other items. In various embodiments, a base of a dispenser may be secured at a location where one or more pods of the dispenser may be readily accessed by an individual's mouth, or where the one or more pods may be readily brought to an individual's mouth. When an individual needs or wants to access an item from a pod of the dispenser (e.g., take a pill, eat a piece of candy, etc.), he or she may manipulate an item-containing pod of the dispenser in a manner that removes the item from the pod. Without limitation, the individual may position the item-containing pod of the dispenser in his or her mouth (e.g., by moving the pod to his or her mouth, by moving his or her mouth to the location of the pod, etc.). With the pod in the individual's mouth, the individual may use his or her lips, teeth, and/or tongue to manipulate the outer wall of the pod in a manner that opens the slit and forces the item out of the hollow interior of the pod, through the slit and into his or her mouth. Alternatively, the individual may use his or her mouth to apply suction to the pod and the item therein, until the item is drawn into the individual's mouth. The individual may then orally consume (e.g., swallow, etc.) the item.

Embodiments of a dispenser with a base that is configured to be secured to an individual's arm, wrist, shoulder or any other readily accessible location may be used during physical exercise, such as while an individual trains for or participates in a physical endurance activity (e.g., marathon running, an IRONMAN® triathlon competition, bicycling, etc.), in which an individual may want or need electrolyte supplementation, nutritional supplementation or the like (e.g., in the form of a pill, etc.). The base may be secured to the individual in such a way that one or more pods of the dispenser face outward from the base. When access to a pill is desired, the individual may place a pod that includes a pill in his or her mouth, remove the pill from the pod and swallow the pill without any significant disruption of his or her physical activity.

In another example of use, a dispenser may be secured to an individual or to an object close to an individual who has trouble using his or her hands (e.g., an individual with arthritic hands, etc.) cannot use his or her hands (e.g., a quadriplegic, etc.), or who lacks one or both hands (e.g., an amputee, etc.) at a location where he or she can readily access one or more pods of the dispenser with his or her mouth. Such an individual may access an item, such as a pill, merely by moving his or her head toward the dispenser, placing his or her mouth over an item-containing pod of the dispenser, removing the item from the pod and, if the item is a consumable item, such as a pill, swallowing the item.

Some individuals, including children, may wear a dispenser according to this disclosure to provide them with a convenient location to store their pills and/or to provide them with a visible reminder that they need to take their pills. In embodiments where a dispenser provides an audible reminder, an individual may readily access his or her pills with a reduced likelihood of intervening distractions, which might otherwise pose a problem if the individual has to travel from one location to another to retrieve his or her pills.

Of course, a dispenser may be used to enable an individual to take a pill under a variety of other circumstances, under a number of different conditions and/or during a wide range of activities.

In another aspect, a dispenser according to this disclosure may be used as a toy or a novelty item. Such a dispenser may have a decorative appearance (e.g., bright colors, images, logos, etc.), and may include one or more features (e.g., electronics, including lights and/or sounds; etc.) that attract attention or provide an individual with some amusement. In such embodiments, the pods of the dispenser may be filled with pieces of candy or other items, which an individual, such as a child, may readily access with his or her hands and/or mouth.

Other aspects, as well as features and advantages of various aspects, of the disclosed subject matter will become apparent to those or ordinary skill in the art through consideration of the ensuing description, the accompanying drawings and the appended claims.

### BRIEF DESCRIPTION OF THE DRAWINGS

In the drawings:

FIG. 1 illustrates an embodiment of a dispenser according to this disclosure, showing a plurality of pods, each comprising an outer wall including a compliant, resilient material and including a slit through which a hollow interior of the pod may be accessed, with the slit in a closed position;

FIG. 1A depicts another embodiment of dispenser according to this disclosure;

FIG. 2 illustrates the embodiment of dispenser of FIG. 1 worn around an individual's wrist;

FIG. 3 shows a pod of the embodiment of dispenser of FIG. 1, with a slit of the pod in an open position;

FIG. 4 depicts another embodiment of dispenser according to this disclosure; and

FIG. 5 is a schematic of the electrical circuitry of an embodiment of dispenser that provides an indicator of a status of each pod (e.g., filled, empty, etc.) and makes a sound when each pod is opened or when an object is removed from that pod.

### DETAILED DESCRIPTION

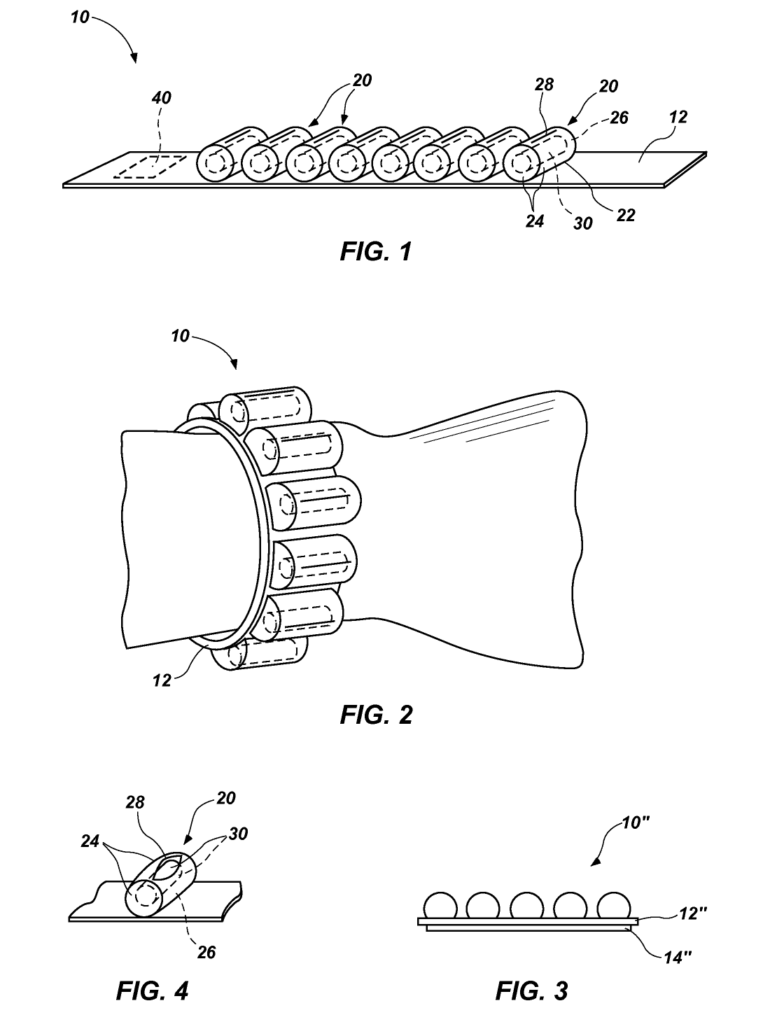

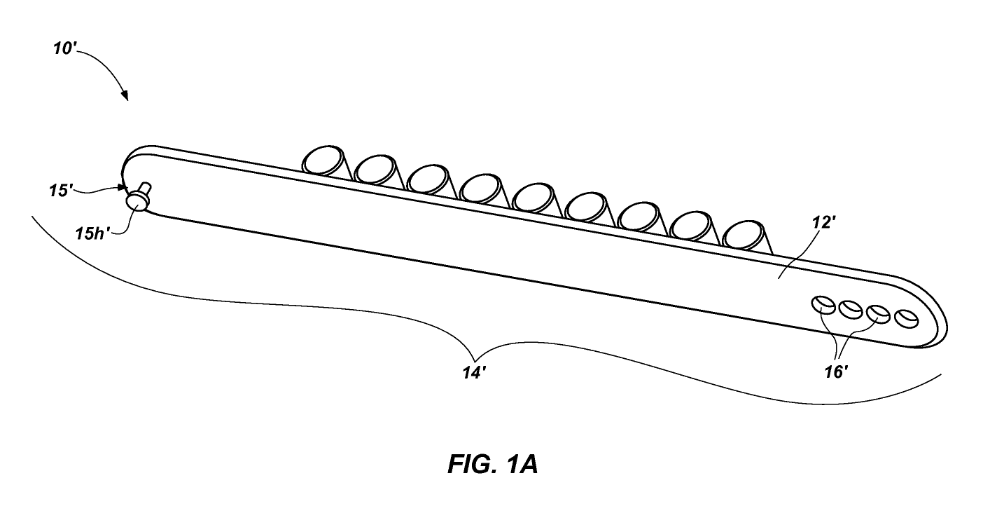

With reference to FIG. 1, an embodiment of a dispenser 10 according to this disclosure is illustrated. The dispenser 10 includes a base 12 that carries one or more pods 20. In the illustrated embodiment, the base 12 carries a plurality of pods 20, which each pod 20 protruding from the base 12. In some embodiments, the dispenser 10 may be operated with an individual's mouth. The pods 20 of such a dispenser 10 may protrude from the base 12 in such a way that each pod 20 may be individually introduced into an individual's mouth. The pods 20 may be arranged adjacent to one another along a length of the base 12. In some embodiments, the pods 20 may be spaced apart from one another by a distance sufficient to enable an individual to introduce a single pod 20 into his or her mouth.

The base 12 of the dispenser 10 may, as illustrated by FIG. 1, be configured to be placed over and, in some embodiments, engage, part of an individual's body. More specifically, the base 12 of the dispenser 10 may be configured to be carried by an individual's wrist, as illustrated by FIG. 2, an arm or a shoulder. In a specific embodiment, such as that depicted by FIG. 1, the base 12 of the dispenser 10 may comprise a slap bracelet. Alternatively, as shown in FIG. 1A, the base 12′ of a dispenser 10′ according to this disclosure may comprise a silicone wristband with a securing element 14′ that may comprise a protruding element, or a snap 15′, at one end of the base 12′ and, at the other end of the base 12′, one or more holes 16′ that are configured to receive the snap 15′ and to be engaged by an enlarged head 15h′ of the snap 15′. As another option, the base may comprise a molded, continuous loop wristband, or a so-called “rubber wristband,” which may be formed from an elastic material that enables it to be stretched as it is pulled over an individual's hand and onto the individual's wrist. In other embodiments, the base of a dispenser may comprise a bracelet (e.g., a medical alert bracelet, etc.) or a similarly configured apparatus, which may include any suitable type of securing element (e.g., cooperating members of a clasp, a buckle, a clip, etc.). Of course, such an apparatus, or base 12, could be secured to objects other than parts of an individual's body.

As illustrated by FIG. 3, as an alternative to being configured to be carried by part of an individual's body, a dispenser 10″ may include a base 12″ that is configured to be secured to another object, such as an article of clothing or another object that may be easily accessed by an individual (e.g., a bed, a wheelchair, etc.). Accordingly, such a base 12″ may include a securing element 14″ configured to hold the dispenser 10″ in place relative to another object. Some non-limiting examples of securing elements include the hooks side of a hook and loop fastener, such as VELCRO®, a clip, a magnet, an adhesive material, a pin or the like.

Alternatively, a base 12″ of a dispenser 10″ or, more specifically, a securing element 14″ associated with the base 12″ may be configured to enable the attachment of the dispenser 10 and its one or more pods 20 to a wearable item or device an individual already wears on his or her wrist, such as a wristwatch, a fitness monitor, an activity tracker, another wrist device or the like. Of course, such an embodiment of base may comprise one or more loops that are configured to receive and/or to be received by a portion of the wearable item. Of course, other embodiments of the bodies of dispenser that include pods according to this disclosure also within the scope of this disclosure.

Turning back to FIG. 1, each pod 20 includes a base 22 secured to the base 12 of its dispenser 10. In addition, each pod 20 includes an outer wall 24, a hollow interior 26 defined the outer wall and a slit 28 that provides a passage between through the outer wall 24.

The outer wall 24 of the pod 20 may be formed from a material that is compliant and resilient. Silicones and similar materials may be used to form the outer wall 24 of the pod 20. The compliance of such a material may enable squeezing of the outer wall 24, while the resilience of the material from which the outer wall 24 is formed may enable the outer wall 24 to return or substantially return to its normal, relaxed shape when force (e.g., a compressive, squeezing force, etc.) is released from the outer wall 24.

As shown, the outer wall 24 may have a substantially cylindrical or semi-cylindrical shape, with one side of the pod 20—the base 22 of the pod 20—being located adjacent to and, optionally, being secured in place relative to the base 12 of the dispenser 10 or directly to the base 12. Accordingly, the outer wall 24 and, thus, the pod 20 may protrude from the base 12 of the dispenser 10. A pod 20 that includes an outer wall 24 with such an elongated cylindrical shape, such as that shown in FIG. 1, or any other elongated shape may be oriented transverse to a length of the base 12; i.e., its length or height may be oriented at a nonparallel angle (e.g., perpendicular, substantially perpendicular, etc.) to a length of the base 12.

The outer wall 24 of the pod 20 defines the hollow interior 26 of the pod 20. The hollow interior 26 may be configured to receive an item 30, such as a pill, a piece of candy or another item. A shape and dimensions of the hollow interior 26 may be configured to receive a particular shape, or even a particular type of item 30.

In the depicted embodiment, the slit 28 of the pod 20 is located at an opposite side of the outer wall 24 from the base 22 of the pod 20. The slit 28 may comprise a substantially linear opening through the outer wall 24 that provides a passageway between the hollow interior 26 of the pod 20 and an exterior of the pod 20. In some embodiments, the slit 28 may extend at least partially into ends of the outer wall 24. The slit 28 is configured to enable removal of an item 30 from the hollow interior 26, as well as the introduction of an item 30 into the hollow interior 26. FIG. 1 shows the slit 28 in a closed position, in which the hollow interior 26 of the pod 20 and its contents may be shielded from, or unexposed to, an environment in which the pod 20 is located.

Upon manipulating the outer wall 24 of the pod 20, such as by squeezing or otherwise applying pressure to the outer wall 24, applying suction to locations of the outer wall 24 around the slit 28, etc., the slit 28 may be forced into an open position, such as that depicted by FIG. 4. While the slit 28 is in its open position, the hollow interior 26 of the pod 20, as well as its contents (e.g., an item 30 (FIG. 3), etc.), if any, may be exposed to an environment in which the pod 20 is located. Thus, the open position of the slit 28 enables the insertion of an item 30 into the hollow interior 26 of the pod 20 or the item 30′s removal from the hollow interior 26 and, thus, from the pod 20.

With returned reference to FIG. 1, the pods 20 of a dispenser 10 according to this disclosure may have an appearance that corresponds to a type of item 30 within that pod 20, the time of day at which the item 30 in that pod 20 is to be taken, or any of a variety of other factors. In a more specific embodiment, the pods 20 may be color-coded.

Some embodiments of dispensers 10 according to this disclosure, including embodiments that are configured to be worn on an individual's wrist, may include an associated device 40, such as a watch, a timer, a fitness monitor, an activity tracker, a portable digital media player, a global positioning system (GPS) receiver or the like. The associated device 40 of a dispenser 10 may comprise one or more electronic devices that provide an individual with an alert when the time has arrived for them to retrieve an item (e.g., a pill) from a pod 20 of the dispenser 10.

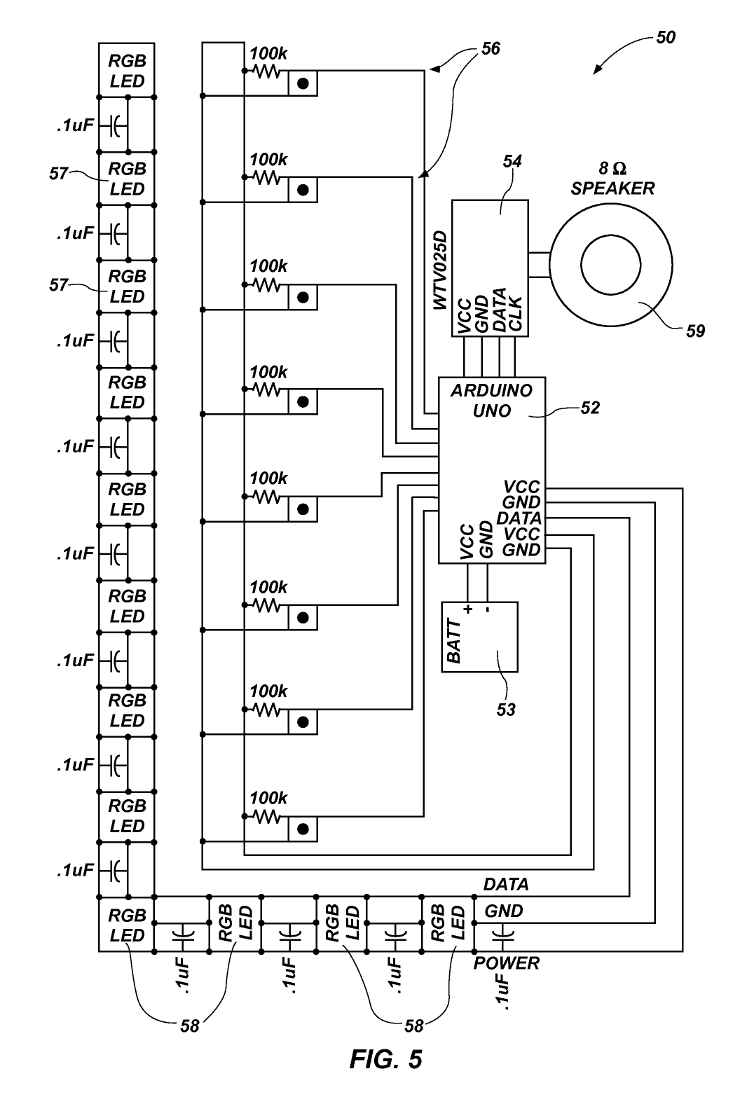

Optionally, a dispenser 10 may include electronic componentry 50 that senses or detects the presence and/or absence of an item 30 from a pod 20 or that senses or detects manipulation (e.g., opening, etc.) of the pod 20, and that provides perceptible indicators of the status of the dispenser 10 and/or its pods 20. FIG. 5 illustrates a specific, but non-limiting embodiment of such electronic componentry 50. Specifically, FIG. 5 illustrates a microcontroller 52 (e.g., Arduino UNO, etc.—which may be configured to communicate wirelessly), a power source 53 (e.g., a battery, etc.) associated with the microcontroller 52 and other components, and an optional memory device 54 (e.g., a secure digital (SD) card reader, etc.) associated with the microcontroller 52, as well as a plurality of sensors 56 and, a plurality of pod status indicators 57, a plurality of device status indicators 58 and an audio output element 59. Each sensor 56 is associated with a pod 20 (FIG. 1) of the dispenser 10 (FIG. 1), and may be configured to determine whether or not an item 30 (FIG. 1) is present within the pod 20, whether or not the pod 20 has been manipulated and/or whether or not an individual has touched his or her mouth, finger, etc., to the pod 20. Each pod status indicator 57 is also associated with a pod 20, and may be configured to provide a visible indicator (e.g., by way of a light-emitting diode (LED), etc.) of whether or not an item 30 is present within the pod 20 (e.g., a green light if an item 30 is present, a red light is the pod 20 is empty, etc.). The device status indicators 58 may provide visual indicators of whether or not the electronic componentry 50 of the dispenser has been powered “on,” a wireless connection status (e.g., WiFi, etc.) of the electronic componentry 50 or any other desired device status output.

With reference again returned to FIG. 1, when electronic components of the type shown and described in reference to FIG. 5 are used in conjunction with a wireless communication component, they may generate signals that are indicative of whether or not an individual has removed an item 30 from its pod 20, of the time of day at which the item 30 was removed from the pod 20 and the like—information that may be transmitted to a remote location (e.g., wirelessly to another device, such as a device used by the individual, to a server that communicates with other devices via the internet, etc.) from which an individual's likely usage of the dispenser 10 may be tracked.

In some embodiments, a dispenser 10 according to this disclosure may be made available to or provided to individual with its pods 20 empty. An individual who uses the dispenser 10 may then place one or more slits 28 in their open positions, and then introduce items 30 into the hollow interiors 26 of the pods 20. The filled pods 20 may then be released to enable the slits 28 to close, and the dispenser 10 may stored or be placed at a location from which the pods 20, and the items 30 inside the pods 20, may be readily accessed.

As an alternative, a dispenser 10 may be provided to a consumer in a prefilled state; i.e., with an item 30 in one or more of its pods 30. When the time approaches for an individual to remove one or more of the items 30 from their respective pods 20, the individual may place the dispenser 10 at a location where he or she may readily access one or more of the pods 20 to remove its contents (i.e., the item 30) from the hollow interior 26 of each of the pods 20.

An item 30 may be removed from the hollow interior 26 of a pod 20 by squeezing or otherwise manipulating the outer wall 24 of the pod 20 in a manner that places the slit 28 in its open position. In some embodiments, such manipulation may be accomplished orally—by introducing the pod 20 substantially or completely into an individual's mouth, enabling the individual to manipulate the outer wall 24 with his or her lips, teeth and/or tongue, or by applying suction to the outer wall 24 of the pod 20.

With the slit 28 though the outer wall 24 of the pod 20 in its open position, as illustrated by FIG. 3, an item 30 may be removed from the hollow interior 26 of the pod 20. Removal of the item 30 may be accomplished under the same force that manipulates the outer wall 24 (e.g., a squeezing force, etc.), by sucking the item 30 from the hollow interior 26 of the pod 20 and through its slit 28, by pulling the item 30 out of the hollow interior 26 and through the slit 28 (e.g., with the individual's tongue, with a foam or foam rubber material (e.g., a moldable foam, a memory foam, etc.), etc.), by way of a spring (e.g., a leaf spring, a under force of gravity (i.e., by inverting the pod 28 while the slit 28 is open, by any other suitable technique, or by any suitable combination of techniques.

Although the foregoing disclosure provides many specifics, these should not be construed as limiting the scope of any of the ensuing claims. Other embodiments may be devised which do not depart from the scopes of the claims. Features from different embodiments may be employed in combination. The scope of each claim is, therefore, indicated and limited only by its plain language and the full scope of available legal equivalents to its elements.

What is claimed:

1. A dispensing device, comprising:
at least one pod, each pod including:
an outer wall comprising a compliant, resilient material;
a hollow interior defined by the outer wall, the hollow interior configured to receive an item;
a slit defined through the outer wall, the slit having:
a closed position in which access to the hollow interior of the pod is limited; and
an open position in which the hollow interior of the pod and any contents within the hollow interior are exposed, the open position of the slit configured to enable insertion of the item into the hollow interior and removal of the item from the hollow interior; and
a base for carrying the at least one pod, each pod protruding from the base in a manner that enables placement of a mouth of an individual around the pod, the slit and the outer wall of the pod being oriented to enable the mouth of the individual to open the slit and to move a item from the hollow interior of the pod into the mouth of the individual, and the outer wall of the pod being configured to close the slit upon removal of the pod from the mouth of the individual.

2. The device of claim 1, wherein the base is configured to be worn on a wrist of the individual.

3. The device of claim 2, wherein the base comprises a slap bracelet.

4. The device of claim 1, wherein the base is configured to be secured to an item of clothing worn by the individual.

5. The device of claim 1, wherein the slit of the pod is oriented transverse to a length of the base.

6. The device of claim 1, comprising a plurality of pods arranged adjacent to one another along a length of the base.

7. The device of claim 1, the outer wall of the pod is substantially cylindrical in shape.

8. The device of claim 7, wherein the slit of the pod extends along a length of the cylinder.

9. The device of claim 8, wherein the compliant, resilient material comprises a silicone.

10. The device of claim 1, further comprising:
the item within the hollow interior of the pod.

11. The device of claim 1, further comprising:
an electronic component configured to alert the individual at a prescheduled time the item is to be consumed.

12. The device of claim 11, wherein the electronic component is further configured to detect removal of the item from the hollow interior of the pod.

13. A dispensing method, comprising:
securing a dispenser to a location on a body of an individual that can be accessed by a mouth of the individual or that can move to the mouth of the individual, the dispenser including at least one pod containing an item, the pod configured to protrude from a remainder of the dispenser in a manner that enables introduction of the pod into the mouth of the individual, the pod oriented for introduction into the mouth of the subject;
introducing the pod into the mouth of the individual; and
squeezing the item from the pod while the pod is present within the mouth of the individual.

14. The method of claim 13, wherein the acts of introducing and squeezing are performed while the individual participates in an athletic event.

15. The method of claim 14, wherein the acts of introducing and squeezing are performed while the individual participates in a physical endurance event.

16. The method of claim 14, wherein securing the dispenser comprises securing the dispenser on a wrist, an arm or a shoulder of the individual.

17. The method of claim 14, wherein securing the dispenser comprises securing the dispenser to an item of clothing worn by the individual.

18. The method of claim 14, wherein the act of squeezing comprises squeezing a pill comprising an electrolyte from the pod.

19. The method of claim 13, wherein the acts of introducing and squeezing are performed by an individual who cannot manually open a bottle.

20. The method of claim 19, wherein securing the dispenser comprises securing the dispenser to clothing worn by the individual.

21. The method of claim 13, further comprising:
introducing another item into the pod.
